(19) United States
(12) Patent Application Publication
(10) Pub. No.: US 2004/0234443 A1
(43) Pub. Date: Nov. 25, 2004

(54) Calcium carbonate of different shapes and the preparation process thereof

(76) Inventors: Jianfeng Chen, Beijing (CN); Yuhong Wang, Beijing (CN); Zhigang Shen, Beijing (CN); Guangwen Chu, Beijing (CN); Wancheng Zhu, Beijing (CN)

Correspondence Address: HASSE GUTTAG & NESBITT LLC, 7550 CENTRAL PARK BLVD., MASON, OH, 45040, US

(21) Appl. No.: 10/880,724

(22) Filed: Jun. 30, 2004

(30) Foreign Application Priority Data
Dec. 31, 2001 (CN) CN 01145312.5
Mar. 1, 2002 (CN) CN 02105383.9
Dec. 31, 2002 (WO) PCT/CN02/00949

(51) Int. Cl. C01F 11/18

(52) U.S. Cl. 423/432; 423/266

(57) ABSTRACT

This invention relates to calcium carbonate of different shapes including spindle, petal, whisker, needle, flake, ball and fiber. The calcium carbonate of such different shapes has an average particle size in the range of 10 nm-2.5 μm. This invention also relates to a process for preparing the said calcium carbonate with a controllable range of average particle size and different shapes. Precipitated powder of calcium carbonate with a desired shape and a controllable average particle size is obtained by carbonizing a suspension of calcium hydroxide and a feed gas containing carbon dioxide on a revolving bed under the gravitational field, and optionally in the presence of a crystal form-controller and/or crystal seeds. The precipitated powder of calcium carbonate obtained by the process according to this invention has a controllable average particle size and a narrow particle distribution. It can be utilized, as desired, in various fields such as rubber, plastics, papermaking, coatings, building materials, inks, paintings, food, medicine, domestic chemical industry, textile and feed.

### TECHNICAL FIELD

The present invention relates to a process of manufacturing morphological calcium carbonate (CaCO₃) and, in particular, to a process of manufacturing morphological CaCO₃, having micro-morphologies such as whisker, plate, spindle, rosette, flake, needle and fibre, and to morphological calcium carbonate obtained from the process and use thereof.

### BACKGROUND OF THE INVENTION

Calcium carbonate (CaCO₃) is one of the most important inorganic chemical products, which is widely used in rubber, plastics, paper manufacturing coating, building materials, printing ink, food, pharmaceutical, daily-use chemical, textile and feedstuff industries. However, there are different requirements on physical and chemical properties of CaCO₃ in different fields. Especially, the morphology and size of CaCO₃ particles greatly influence the performances of materials in which CaCO₃ has been added.

For example, in paper manufacturing industry, spindle or rosette type, especially rosette type CaCO₃ is needed than other types. These types of CaCO₃ can relieve the degree of agglomeration of CaCO₃ particles and ensure the good air permeability, brightness and opaqueness of paper. And by adding these types of CaCO₃, the paper can be thinner and have a desirable abrasion resistance of paper network structure. For the use in electronic ceramics, CaCO₃ is required to have a relatively high purity and should be superfine spherical type CaCO₃. Generally, it is said that CaCO₃ having high specific surface area (such as plate, flake, needle or fibre) is more suitable for strengthening the mechanical properties (i.e. intensifying, toughening, volume-improving) and burning resistance of rubber, plastics and paper. As to whisker type CaCO₃, because it is a kind of chopped fibre formed in form of monocrystalline which has perfect crystalline structure and has much smaller size relative to general chopped fibres, mechanical intensity of the whisker type CaCO₃ approximates to the theoretical value of valence bond force among atoms. As a result, the whisker type CaCO₃ has wider use than general granular fillers in many fields nowadays. In the meanwhile, whisker type CaCO₃ has been proposed to use as an additive for reinforcing composite materials which has excellent mechanical properties because of its special morphology of large aspect ratio.

Therefore, according to different uses, CaCO₃ particles having different crystalline forms, morphologies and/or mean particle sizes are needed.

In recent years, there are numerous researches about the controlling of crystalline form, morphology and size in the world. For example spindle type CaCO₃ was described in Japanese Lain-open Patent Publication No. 5-238730, Japanese Lain-open Patent Publication No. 59-26927, Japanese Lain-open Patent Publication No. 1-301510, Japanese Lain-open Patent Publication No. 2-243513, wherein the expected morphological CaCO₃ can be achieved by adding morphology-controlling agents in conventional agitating tank or bubbling tower. Moreover, a process of preparing needle type CaCO₃ through carbonization reaction scheme, from calcium hydroxide (Ca(OH)₂) suspension in the presence of its seed crystal and phosphate acid was described in U.S. Pat. No. 5,164,172. The researches and developments of getting thinner, more perfect morphology of CaCO₃ and of a process of controlling CaCO₃ morphology have become a hot spot of competition among many countries. Lots of patents have been emerged, for example, Japanese Lain-open Patent Publication No. 59-223225, Japanese Lain-open Patent Publication No. 67-278123.

Moreover, the existing technologies, for instance [LIU Qingfeng et al. Preparation of Calcium Carbonate Whisker, INORGANIC CHEMICALS INDUSTRY, 2000-03, 32(2): 11-12; Sutton W. H. SPE, 1964, 1203; Scheefler L. F., Reinforced Plastics, 1967, 244; Koshima, Journal of Ceramic Society of Japan 1992, 100(9): 1145-1153] disclose some conventional manufacturing process of whisker type CaCO₃, comprising: (a) Ca²⁺ in an aqueous solution (e.g., Ca(NO₃)₂) was reacted with CO₃²⁻ (e.g., as K₂CO₃) in an aqueous solution at an temperature of 90 degrees Celsius for a period of time and CaCO₃ whisker having a length of 15 μm and a diameter of 1 μm was synthesized. Although the length of the whisker increases when the concentration of the reactant solutions, calcite type cubic CaCO₃ whose length side is 1 μm was also produced concomitantly, which was not expected; (b) CaCO₃ whisker of 40-160 μm in length and 1-3 μm in diameter can be crystallized by controlling the heating temperature (750 degrees Celsius) of Ca(HCO₃)₂ solution, increasing temperature rate and agitating speed; (c) Ca(OH)₂ and CO₂ were took place gas-liquid reaction to produce CaCO₃, but it must add 1-2 μm needle type CaCO₃ seed crystal and phosphate-based compounds which are benefit for the growth whisker type CaCO₃ in the direction of whisker length; and (d) a process of manufacturing whisker type CaCO₃ by carbonization comprising the steps of slaking CaO obtained from CaCO₃ in water and then adding the resultant from the above into a large amount of MgCl₂ to prepare a suspension, heating the suspension to 80-85 degrees Celsius and introducing CO₂ gas at the flow rate of 0.1 L/min to conduct carbonization reaction. After the reaction finishes, precipitated product was filtered, washed and dried to get aragonite CaCO₃ whisker of 35-45 μm in length and 2-3 μm in diameter, which is mainly used in composite plastics. As to the reaction conditions, LIU Qingfeng et al. [Preparation of Calcium Carbonate Whisker, INORGANIC CHEMICALS INDUSTRY, 2000-03, 32(2): 11-12;] discloses that reaction time was lasting 180 min, and GUO Jinhuo et al. [A study on crystallization Process of calcium carbonate whiskers, MINING AND METALLURGICAL ENGINEERING, 1999, 19(4): 58-60] illustrates that it needed 145 min to complete the reaction of preparing CaCO₃ wherein additive agents were added for controlling to form the crystal(s) in a single direction.

All the documents including application and patents are cited in the application as references.

Generally, there were four kinds of process of manufacturing light CaCO₃ (morphological CaCO₃) as follows:

(1) Liquid-liquid reaction in which the solution of Ca²⁺ (i.e. Ca(NO₃)₂, Ca(CH₃COO)₂, CaCl₂ or Ca(CH₃CHOHCOO)₂) was reacted with CO₃²⁻ solution (i.e. Na₂CO₃, K₂CO₃ or (NH₄)₂CO₃).

(2) Thermal decomposition of Ca(HCO₃)₂.

(3) Re-crystallization of amorphous CaCO₃.

(4) Carbonization crystallization process. In the process Ca(OH)₂ was reacted with CO₂ directly or after morphology-controlling agents were added.

According to the processes mentioned above, different crystalline forms, sizes and CaCO₃ morphologies can be obtained for the different demands of practical fields.

In the aspect of the preparation of CaCO₃ and morphology-controlling in the world, carbonization crystallization (hereinafter referred to as carbonization) is carried out under normal gravitational field, that is to say, under the condition of earth gravity field. Conventional agitating tank or bubbling tower is adopted as carbonization reactor. CO₂ gas is introduced into carbonization tank containing the suspension of Ca(OH)₂, or tower to take place carbonization, and morphology-controlling agent(s) or seed crystal(s) can be added as well for obtaining various morphologies of CaCO₃ or superfine CaCO₃ having different morphologies.

Conventional manufacturing processes of CaCO₃ as described above are generally proceeded in agitating tank or bubbling tower. The reaction time is long, for mass transfer rate of gas-liquid-solid interface is slow and micro-mixing is poor in such reactors. Moreover, there are such shortages of the CaCO₃ products obtained from this kind of carbonization that: (1) the product having a morphology is not unity; (2) size distribution is not uniform and narrow; (3) the quality of particles cannot satisfy the wants of downstream industries; (4) reaction time is long. There are many limitations to these conventional manufacturing processes and the application of CaCO₃ products obtained by the processes of conventional carbonization.

Meantime, the diameter of whisker type CaCO₃ from the existing manufacturing processes is usually big, and mean diameter is almost between 1.0-3.0 μm. The smallest mean diameter mentioned in the present documents is only 0.5 μm. The diameter or aspect ratio distributes widely. It lasts a relative long reaction time, and needs to add CaCO₃ seed crystal in advance (as in Process c above), which is not easily available, or expends a large amount of additive agents (as in Process d). So in the prior art processes of preparing the whisker CaCO₃, the processes are complicated and long reaction time are needed for obtaining seed crystal and recovering the additive agents, which results in high costs and difficulty for industrialization.

Thus, there is still a need for a process meeting the following requirements: CaCO₃ having different morphologies can be prepared; the reaction of preparing morphological CaCO₃ is conducted rapidly; desired morphology and size distribution of CaCO₃ can be obtained by controlling reaction conditions; less time for the reaction is needed; and the obtained CaCO₃ can be used in situ in the next use. Through this process, the reaction is accelerated and high qualities products that have a required size distribution and can be used directly can be attained. At the same time, the process can save reaction time and steps, suit for industrial production and fulfill needs of environmental protection as well.

In view of the foregoing, inventors of the invention surprisingly find that under the condition of high gravity, for instance, in Rotating Packed Beds (RPBs) reactor, Ca(OH)₂, preferably Ca(OH)₂ slurry (suspension), and a reactant containing CO₂, preferably a gas containing CO₂, take place carbonization, wherein morphology-controlling agents and/or seed crystal is optionally added, all morphologies of CaCO₃, especially superfine CaCO₃, including whisker, spindle and/or rosette, fibre, flake, needle, and sphere are obtained.

An object of this invention is to supply a process of manufacturing CaCO₃.

Another object of the present invention is to provide a process, through which all morphologies of CaCO₃ can be obtained.

Thirdly, the present invention supplies a process of manufacturing morphological CaCO₃, in which the size of mean diameter of the CaCO₃ can be controlled.

Another object of the present invention concerns with the CaCO₃ prepared by the process mentioned above.

Another object of the present invention relates to the use of CaCO₃ produced by preceding process.

### SUMMARY OF THE INVENTION

The present invention provides a process of manufacturing morphological CaCO₃. The process comprising the step of conducting a carbonization reaction of Ca(OH)₂ and CO₂ under high gravity condition at about 0 degrees Celsius to about 90 degrees Celsius.

The term “high gravity condition” herein is provided by high gravity reactor. The term “high gravity reactor” herein contains the well-known rotating (packing) beds high gravity reactor (RPBs high gravity reactor), for example those disclosed in Chinese Patent ZL 95107423.7.

In one of the preferable embodiments, the process of manufacturing morphological CaCO₃ according to the invention comprising: a suspension of Ca(OH)₂ is reacted with a gas containing CO₂ in RPBs high gravity reactor at a temperature around 5-85 degrees Celsius, preferably in the presence of morphology-controlling agents and/or a seed crystal.

According to the process of the invention, when RPBs high gravity reactor is used, rotating speed of the rotor in the rotating beds of RPBs high gravity reactor is about 50-5000 rpm. In such range, common technicians in this field can determine the specific rotating speed to gain mean size CaCO₃ as expected. Preferably the rotating speed is over 100 rpm, more preferably over 300 rpm, and still more preferably less than 3000 rpm. As is well-known to common technicians in this field that the larger the rotor is, the lower the rotating speed is.

According to the process of the invention, when morphology-controlling agents are used, they are one or more selected from the group consisting of: phosphoric acid and its salts, boric acid and its salts, hydroxide, chloride, ammonia, oxydol (H₂O₂) or the mixture thereof. Preferably, the morphology-controlling agent is selected from the group consisting of alkali metal, alkaline earth metal or ammonium of phosphate, monohydrogen phosphate, dihydrogen phosphate, borate, monohydric borate, dihydrogen borate, ortho-borate, meta-borate, nitrate, hydroxide, and chloride, ammonia, boric acid, phosphoric acid, oxydol (H₂O₂) and the mixture thereof, more preferably the morphology-controlling agent is selected from Na₃PO₄□Na₂HPO₄, NaH₂PO₄, K₃PO₄, K₂HPO₄, KH₂PO₄, (NH₄)₃PO₄, (NH₄)₂HPO₄, (NH₄)H₂PO₄, sodium borate, sodium meta-borate, boric acid, phosphoric acid, sodium hydroxide, magnesium chloride, calcium chloride, ammonia spirit, oxydol (H₂O₂) or the mixture thereof.

According to the process of the invention, different morphologies such as whisker, spindle and/or rosette, fibre, flake, needle or sphere type of CaCO₃ is obtained.

According to the process of the invention, CaCO₃ as needed with respect to morphology, size and crystalline form can be obtained by selecting proper technological parameters, including reaction temperature, rotating speed of RPBs, pH value, morphology-controlling agents and/or seed crystal of expected morphology.

The morphological CaCO₃ prepared by the process of the invention is better than that obtained from existing technologies, and mean particle size of the CaCO₃ is extreme thinner than that by conventional process of existing technologies. Furthermore, according to the present invention, the mean particle size of the CaCO₃ can be controlled and size distribution of the CaCO₃ is narrow by maintaining rotating speed of RPBs and reaction temperature uniformly. According to the present process, reaction time of the invention using high gravity reactor for preparing the expected forms and uniform size distribution of the CaCO₃ dramatically declines.

### BRIEF DESCRIPTION OF THE DRAWINGS

FIG. 1 is a side view drawing of the shortened reaction procedure in one of the actual examples.

FIG. 2(a) stands for the TEM photograph of spindle or rosette type CaCO₃ attained by the process of the present invention.

FIG. 2(b) stands for the TEM photograph of fibre type CaCO₃ attained by the process of the present invention.

FIG. 2(c) stands for the TEM photograph of spherical type CaCO₃ attained by the process of the present invention.

FIG. 2(d) stands for the TEM photograph of flake type CaCO₃ attained by the process of the present invention.

FIG. 2(e) stands for the TEM photograph of needle type CaCO₃ attained by the process of the present invention.

FIG. 3 is the XRD patterns of superfine CaCO₃ of the present invention, which has the same morphologies as FIG. 2(a).

FIG. 4 stands for the TEM photograph of whisker type CaCO₃ attained in one of the actual examples of the present invention.

FIG. 5 stands for the TEM photograph of whisker type CaCO₃ attained in one of the actual examples of the present invention.

FIG. 6 is the mean particle size distribution column of the whisker type CaCO₃ attained by the process of the present invention.

FIG. 7 is the aspect ratio distribution column of the whisker type CaCO₃ attained by the process of the present invention.

### DETAILED DESCRIPTION OF THE INVENTION

The present invention provides a process of manufacturing specific form of CaCO₃, which comprises the step of reacting Ca(OH)₂ suspension with a gas of CO₂ in RPBs high gravity reactor at about 0 degrees Celsius to about 90 degrees Celsius, preferably about 5 degrees Celsius to about 85 degrees Celsius, optionally in the presence of morphology-controlling agents or seed crystal.

The reactant, Ca(OH)₂, is always in the form of Ca(OH)₂ slurry (also called Ca(OH)₂ suspension), which is prepared from commercially available Ca(OH)₂ or is prepared from CaO by slaking. The slaking operation of CaO comprises the steps of slaking CaO in water at a suitable lime-water ratio under the condition of agitation, then filtering to get rid of the residue to prepare Ca(OH)₂ suspension. In general, slaking temperature is known to all common technicians in this field, preferably at a temperature of at least about 40 degrees Celsius. The flow rate of Ca(OH)₂ suspension can be selected with respect to the rotating speed of RPBs high gravity reactor in the process of the invention. Particularly, according to the invention, the concentration of Ca(OH)₂ suspension is about 5% to about 12% (by weight), preferably about 5% to about 8% by weight, more preferably about 6% to about 7.5% by weight.

The CO₂ gas suitable for the invention may be a mixture of CO₂ and inert gases which does not react with the reactants of the invention. Preferable content of CO₂ is exceeding 10% by volume, preferably above 50% by volume, and more preferably above 90% by volume.

According to the process of the present invention, specific particles that have various morphologies, mean size ranging in 10 nm to 2.5 μm, and narrow size distribution, can be obtained by choosing proper reaction conditions such as reaction temperature, rotating speed of RPBs high gravity reactor and the like. The term “narrow distribution” of the invention is known as that almost more than 50 percentage particles are located in the range of the same order of mean size, and the number of particles surpassing the range is minority.

The term “particle size or granularity” of the invention means minor axis or thickness.

According to the process of the invention, it can produce small mean particle size superfine CaCO₃ as in 10 nm to 2.5 μm.

According to the process of the invention, mean size of minor axis of whisker type CaCO₃ is even thinner, generally, smaller than 300 nm. As for spindle or rosette type product, mean particle size (minor axis) is around 300 nm to 2.5 μm, preferably around 600 nm to 1.5 μm. As for fibre type CaCO₃, mean particle size (minor axis) is around 1 nm to 100 nm, and aspect ratio is 3-50, preferably minor axis size is around 10 nm to 100 nm, and aspect ratio is 5-30, more preferably the minor axis size is around 30 nm to 100 nm and aspect ratio is around 5-15. As for needle type CaCO₃, mean particle size (minor axis) is around 10 nm to 1000 nm, and aspect ratio is 5-100; preferably minor axis size is around 20 nm to 500 nm, and aspect ratio is around 10-50; more preferably the minor axis is around 20 nm to 300 nm and aspect ratio is 15-50. As for flake CaCO₃, mean particle size (thickness) is around 10 nm to 500 nm, and the ratio of thickness to length is 5-100; preferable, minor axis size is around 20 nm to 100 nm, and thickness to length ratio is around 5-30; and more preferably to the minor axis is around 20 nm to 300 nm and the thickness to length ratio is 5-20. As for spherical type CaCO₃, mean particle size (diameter) is around 10 nm to 2000 nm; preferably around 20 nm to 1000 nm; and more preferably around 20 nm to 500 nm in minor axis.

The followings are the detailed descriptions of the invention associating with the appendix diagrams.

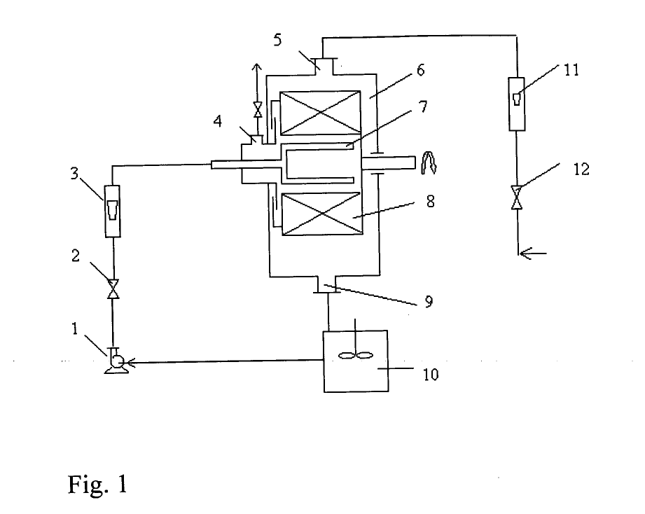

According to one embodiment of the invention, the reaction procedure is as shown in FIG. 1. Ca(OH)₂ suspension is added into tank 10 equipped with agitator, then enter liquid distributor 7 through pump 1, valve 2 and flow meter 3 in sequence. After the high gravity reactor is activated, CO₂ gas was fed into the reactor through gas inlet 5. In the process of rotation generated by the rotor (which is not marked), Ca(OH)₂ suspension and CO₂ gas were conducted a carbonization reaction in packed layer 8 in the presence of optional morphology-controlling agents or seed crystal. The gas that does not consume sufficiently leaves high gravity reactor from gas outlet 13, and the reacted liquid mixture discharges out of high gravity reactor from outlet 9 (liquid outlet). As needed, liquid product drained out of high gravity reactor from outlet 9 can be recycled by introducing it to tank 10, returning to the high gravity reactor and reacting with CO₂ gas. The pH value of the reactant mixture has been monitored during the course of reaction. When it declines to a given value, terminate the reaction. Generally speaking, the reaction stops when pH value is about 6 to about 10, preferably about 7 to about 9 at which a higher yield can be given.

The liquid distributor 7 of the high gravity reactor may have one or more apertures in the light of different requirements.

The packings in the packed beds 8 of the high gravity reactor can include—but not limited—metal and non-metal materials, such as wire net, porous plate, corrugated board, foam materials and regular packings, and so on.

The flow rate of Ca(OH)₂ suspension of the invention can be selected in relation to the rotating speed of RPB high gravity reactor correspondingly. But it should be big enough to maintain a continuous liquid flow in the reactor. For instance, it can be chosen to be at about 4 L/h to about 300 m³/h. As for preparing whisker type CaCO₃, flow rate of Ca(OH)₂ suspension is about 1000 L/h to about 3000 L/h specifically, preferably about 1500 L/h to about 2700 L/h, more preferably about 1800 L/h to about 2400 L/h, based on per kilogram of CaCO₃ obtained from the reaction which is conducted completely.

The gas flow rate in the process of preparing CaCO₃ according to the invention is counted based on net CO₂ at stand state condition, which is controlled at about 0.01 to about 5 m³/h per kilogram of CaO or Ca(OH)₂. As for preparing whisker type CaCO₃, flow rate of CO₂ gas is about 1000 L/h to about 3000 L/h, preferably about 1500 L/h to about 2700 L/h, preferably about 1800 L/h to about 2400 L/h, based on per kilogram of CaCO₃ obtained from the reaction which is conducted completely.

When pH value of reactant mixture of the invention reaches to the pre-set value, the reaction is stopped and the suspension is collected. Then CaCO₃ product is obtained through a series of post treatments, comprises separating, filtering, and drying. The filtrate after extracted CaCO₃ crystal can be reused to prepare Ca(OH)₂ suspension.

If desired, morphology-controlling agents and/or seed crystal can be added into the tank 10 and mixed with Ca(OH)₂ suspension before reaction, or put directly into reaction system during the course of the reaction.

During the course of reaction, morphology-controlling agents can be optionally added depending on the needs for obtaining particular morphology and/or particle size of CaCO₃. For example, but not limited to the following cases, morphology-controlling agents are not needed in the process of preparing spindle or rosette type CaCO₃; materials such as phosphoric acid or phosphate-based materials can be added for preparing fibre type CaCO₃; as for preparing spherical type CaCO₃, morphology-controlling agents such as ammonia or ammonium salt, or oxydol (H₂O₂) may be added, preferably, ammonia and/or oxydol (H₂O₂) or ammonium hydroxide; as for preparing flake CaCO₃, boric acid and its salt and/or oxydol as morphology-controlling agents, preferably alkali mental borate may be added; as for preparing needle CaCO₃, alkaline earth metal chloride and/or alkaline earth metal hydroxide as morphology-controlling agents, preferably magnesium chloride and/or calcium chloride, more preferably magnesium chloride, may be added, wherein alkali metal hydroxide (e.g., NaOH) and/or oxydol (H₂O₂) may be optionally contained. Moreover, a mixture of above morphology-controlling agents may be added. The amount of morphology-controlling agents is easy to determine by common technicians in this field. The mole ratio to the obtained CaCO₃ is general in the range of 0 to about 1, preferably 0 to about 0.5, more preferably about 0.01 to about 0.2.

During the course of reaction, reaction temperature is optional depending on the requirements on crystal form, morphology and/or particle size of CaCO₃ expected. The reaction always proceeds at 0 degrees Celsius to about 90 degrees Celsius, preferably about 5 degrees Celsius to about 85 degrees Celsius. In order to acquire the expected morphologies, e.g., spindle or rosette type CaCO₃, temperature is chosen to be at about 40 degrees Celsius to about 85 degrees Celsius, preferably about 50 degrees Celsius to about 85 degrees Celsius; in order to acquire fibre, flake, spherical or needle type CaCO₃, the temperature is chosen to be lower than about 70 degrees Celsius, generally about 10 degrees Celsius to about 60 degrees Celsius, preferably about 15 degrees Celsius to about 55 degrees Celsius, more preferably about 25 degrees Celsius to about 55 degrees Celsius, or more preferably about 15 degrees Celsius to about 50 degrees Celsius. Generally, depending on the CaCO₃ morphology as needed, the reaction temperature can be regulated during the course of reaction.

According to the process of the present invention, because carbonization reaction takes place under the condition of RPBs high gravity field, micro-mixing and micro-mass transfer of the carbonization process is reinforced, and thus the reaction becomes rapid. The morphological CaCO₃ products according to the present invention such as whisker, spindle, rosette, fibre, sphere, flake or needle are superior in crystalline forms, mean particle size and particle size distribution to those obtained following the prior art process. Meanwhile, in the process of the present invention, mean particle size of obtained products can be controlled by maintaining or adjusting the reaction conditions such as rotating speed of RPBs and reaction temperature, to prepare uniform CaCO₃ crystal (narrow particle size distribution while particle diameter is variable).

### EXAMPLE

The present invention will be explained in more detail with reference to the following examples. However, these are to illustrate the present invention and the present invention is not limited to them. Without departing from the spirit and scope of the invention, a skilled in the art can modify and adjust the invention. All the percentages, values and parts are weight basis, unless specially pointed out. The reaction progress is monitored by pH value. Preferably when the reaction system is at pH 6.5-8, stop inputting the CO₂ and terminate the reaction.

### Example 1

5 kg of CaO stoichiometrically was weighed and added into tank with agitating, water at a temperature above 95 degrees Celsius was added to calcined lime, in which the ratio of the lime to water was 1:10 (by weight). The mixture was stirred adequately and then cooled, filtered to get rid of the residue with standard sieve to prepare Ca(OH)₂ stock liquid. The stock liquid was diluted grossly to Ca(OH)₂ suspension wherein the concentration of Ca²⁺ is 0.8 mol/L. The exact concentration of Ca²⁺ of the Ca(OH)₂ suspension was then determined by EDTA chelatometry. Following the process flow diagram shown as FIG. 1, 3.5 L of the resulted Ca(OH)₂ suspension was fed to the tank 10. Through pump 1 and liquid flow meter 3, the suspension was added to the porous packed layer 8 via liquid distributor 7 at a flow rate of 0.3 m³/h, while industrial pure CO₂ gas was allowed to be added into the reactor after decompressed, and measured by the gas flow meter 11 at a flow rate of 0.3 m³/h. Then the Ca(OH)₂ suspension and the CO₂ gas was reacted in porous packed layer 8 following the reaction scheme below.

Ca(OH)₂+H₂O+CO₂→CaCO₃+2H₂O

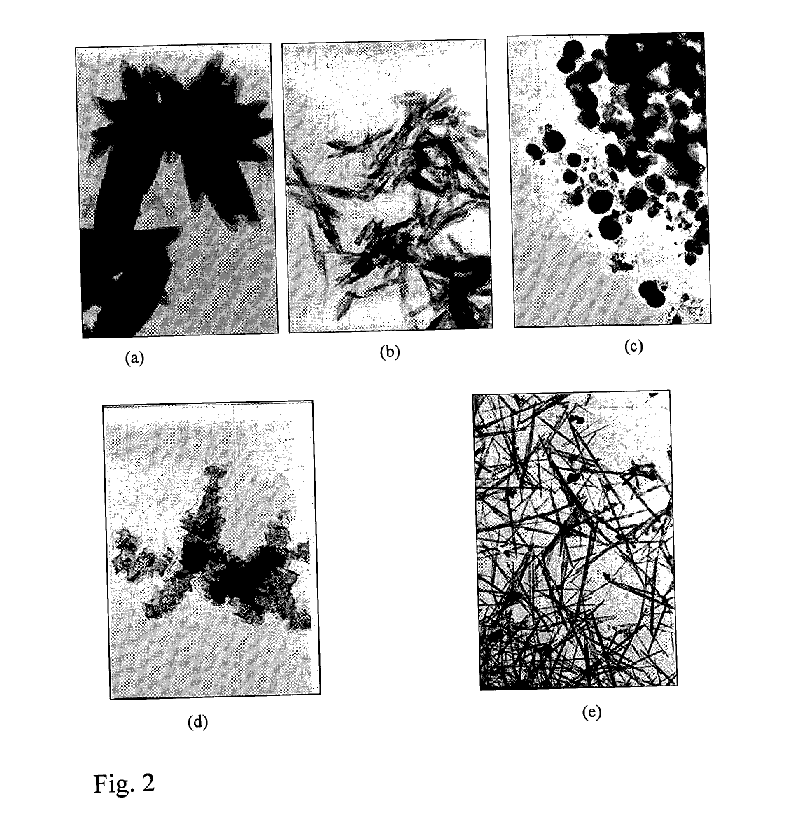

Timing was started when gas was added. In the reactor, the rotating speed of RPBs rotor was 1440 rpm, and temperature of carbonization reaction was carried out at 70 degrees Celsius. After the reaction between Ca(OH)₂ and CO₂ was completed, the liquid-solid mixture was collected into the tank 10 again via liquid outlet 9 of the High gravity reactor and recycled. Until pH value of the suspension achieved about 7˜8, the reaction was stopped. The CaCO₃ product was then tested by TEM (as shown in FIG. 2 (a)). The mean major diameter of the resultant was 1.5 μm and minor axis was 0.5 μm. By XRD-6000 type X-ray diffractometer (Shimadzu Japan), the crystal phase of the particulars was measured. XRD patterns of the product were given in FIG. 3, showing the form of the crystalline form is calcite type.

### Example 2

Same as the example 1, except that the reaction temperature was controlled in the range of 50˜60 degrees Celsius. The dispersibility of the resulted product is better than the example 1, whose morphology tended toward spindle type. Other properties of the product were the same as in the example 1.

### Example 3

Same as the example 1, except that the gas flow rate was changed to 0.5 m³/h. Thus, the whole reaction time of carbonization was shortened. The major diameter of the particle was 1 μm, and minor axis was 0.3 μm by analysis. The morphology was also spindle type.

### Example 4

Same as the example 1, except that the reaction temperature was changed to 15 degrees Celsius and the rotating speed of the rotating beds wad changed 2100 rpm. After two minutes from the start of the reaction, Na₃PO₄ was added wherein the mole ratio of Na₃PO₄ to CaCO₃ is 0.08. When pH was achieved to 7.5, the reaction was stopped. According to TEM, morphology of CaCO₃ powder was fibre type (as shown in FIG. 2(b)). The length of the fibre was 300-700 nm, and width was 30-70 nm. Other properties of the product were the same as in the example 1.

### Example 5

Same as the example 1, except that the reaction temperature was changed to 30 degrees Celsius and the rotating speed of the rotating beds was changed to 2100 rpm. After two minutes from the start of the reaction, Na₃PO₄ was added to the reactor at a ratio to CaCO₃ of 0.08. When pH was 7, the reaction was stopped. By TEM, the morphology of the CaCO₃ powder was fibre type. The length of the fibre was 500-900 nm, and the width was 60-100 nm. Other properties of the product were the same as in the example 1.

### Example 6

Same as the example 1, except that the reaction temperature was changed to 15 degrees Celsius and the rotating speed of the rotating beds was changed to 2100 rpm. The fibre type CaCO₃ obtained from the example 4 was added at a mole ratio to Ca(OH)₂ of 0.01-0.1 as seed crystal to the tank 10 before the carbonization reaction was started. Then to the tank 10, Na₃PO₄ was added at a ratio to Ca(OH)₂ of 0.01-0.1 after the carbonization reaction started 2 min. The reaction was stopped after pH of the mixture was 7.5. The morphology of the CaCO₃ powder was fibre type by TEM analysis. The length of the fibre was 300-1000 nm, and width was 30-100 nm. Other properties of the product were the same as in the example 1.

### Example 7

Same as the example 1, except that the reaction temperature was changed to 15 degrees Celsius and the rotating speed of the rotating beds was changed to 1440 rpm. Then to the tank 10, Na₃PO₄ was added at a ratio to Ca(OH)₂ of 0.08 after the carbonization reaction started 2 min. The reaction was stopped after pH of the mixture was changed to 7.5. The morphology of the CaCO₃ powder was fibre type by TEM analysis. The length of the fibre was 500-900 nm, and width was 30-70 nm. Other properties of the product were the same as in the example 1.

### Example 8

Same as the example 1, except that the reaction temperature was changed to 30 degrees Celsius and the rotating speed of the rotating beds was changed to 1440 rpm. 3.5 L 0.8 mol/L Ca(OH)₂ suspension and NH₄OH at a ratio to Ca(OH)₂ of 0.05 were added to the tank 10. The reaction was stopped after pH of the mixture was changed to 8.5. The morphology of the CaCO₃ powder was spherical type by TEM analysis, as shown in FIG. 2(c). The mean particles size (particle diameter) was around 150 nm, and XRD characterization indicated it was a mixed crystal of calcite, aragonite and vaterite types.

### Example 9

Same as the example 1, except that the reaction temperature was changed to 40 degrees Celsius. H₂O₂ were added to the tank 10 at a mole ratio of 0.01-0.2 to Ca(OH)₂. The morphology of the CaCO₃ powder was spherical type by TEM analysis. The mean particles size (particle diameter) was around 200 nm, and XRD characterization indicated it was a mixed crystal of calcite, aragonite and vaterite types.

### Example 10

Same as the example 1, except that the reaction temperature was changed to 15 degrees Celsius and the rotating speed of the rotating beds was changed to 2100 rpm. 3.5 L 0.8 mol/L Ca(OH)₂ suspension and sodium tetraborate decahydrate at a ratio to Ca(OH)₂ of 0.03 were added to the tank 10. The morphology of the resulted CaCO₃ was flake type by TEM analysis, as is shown in FIG. 2(d). The width of the flake CaCO₃ was about 50 nm, and the thickness was 5-10 nm. XRD characterization indicates it is a mixed crystal of calcite and aragonite types.

### Example 11

Same as the example 1, except that the reaction temperature was changed to 20 degrees Celsius. The width of the flake type CaCO₃ was about 70 nm, and the thickness was 10-15 nm. Other properties of the product were the same as the example 1. XRD characterization indicated that it was a mixed crystal of calcite and aragonite types.

### Example 12

Same as the example 1, except that the reaction temperature was changed to 15 degrees Celsius and the rotating speed of the rotating beds was changed to 2100 rpm. 3.5 L 0.8 mol/L Ca(OH)₂ suspension and NaOH and MgCl₂ at both ratios to Ca(OH)₂ of 0.03 were added to the tank 10. TEM analysis showed that the morphology of the obtained CaCO₃ powder was in the needle type (as shown in FIG. 2(e)). The length of the needle type product was around 800 nm, and width was 30 nm. XRD characterization indicated it was a mixed crystal of calcite and aragonite types.

### Example 13

Same as the example 1, except that the reaction temperature was changed to 40 degrees Celsius and the rotating speed of the rotating beds was changed to 1440 rpm. The morphology of the obtained CaCO₃ powder was needle type from the TEM photographs. The length was around 1000 nm, and the width was 90 nm. XRD characterization indicated it was a mixed crystal of calcite and aragonite types.

### Example 14

Same as the example 1, except that the reaction temperature was changed to 20 degrees Celsius and the rotating speed of the rotating beds was changed to 1440 rpm. As additive agents, NaOH, MgCl₂ and H₂O₂ were added at mole ratios to Ca(OH)₂ of 0.03, 0.01 and 0.01-0.2 to the tank 10. The morphology of the obtained CaCO₃ powder was needle type by anglicizing the photographs from TEM. The length was around 1000 nm, and the width was 50 nm. XRD characterization indicated it was a mixed crystal of calcite and aragonite types.

### Example 15

Same as the example 1, except that the reaction temperature was changed to 40 degrees Celsius and the rotating speed of the rotating beds was changed to 1440 rpm. The needle type CaCO₃ obtained in the example 13 as seed crystal to the tank 10 before carbonization reaction, whose mole ratio to Ca(OH)₂ is 0.01-0.2. Then NaOH and MgCl₂ after the carbonization reaction lasts 2 min were added, whose mole ratio to Ca(OH)₂ were both 0.01-0.2. The morphology of the obtained CaCO₃ powder was needle type by TEM analysis. The length was around 1000 nm, and width was 50 nm. XRD characterization indicated it was a mixed crystal of calcite and aragonite types.

The followings are examples of whisker type CaCO₃.

### Example 16

4.0 kg of industrial grade calcined lime was slaked with 40 L water at 80 degrees Celsius with the ratio of lime: water of 1:10 (by weight). The residue from Ca(OH)₂ suspension was filtered. The concentration was adjusted to about 11.5% (by weight). 2.3 L of the suspension was added into the mixing tank and 0.8 L of water was supplemented. Liquid-feeding pump was started and rotating packed beds was turned on, in which the rotating speed of RPBs was adjusted to 600 rpm. The temperature of circulating water was adjusted to about 50 degrees Celsius. 1.5% by weight of MgCl₂ relative to the obtained CaCO₃ was weighed and added to the reactor. The said additive agent was dissolved with 0.8 L of water and added into the mixing tank. When the temperature of the liquid reactants reached to 49-52 degrees Celsius, the gas flow meter was opened and the reaction started. The gas flow rate was maintained at 240 L/h and liquid flow rate was maintained at 1500 L/h. The pH value was monitored during the process of the reaction. The temperature of the reactants was held to stay at 49-52 degrees Celsius. The CaCO₃ slurry was took out after reaction finished. To the dispersant agent was added several drops of CaCO₃ slurry and ultrasonic dispersion was conducted using KQ-100 type ultrasonic cleaner. Samples were prepared for observing the morphology by TEM. The obtained powder product was dried and tested for its crystalline form by XRD. Statistical analysis disclosed that whisker type CaCO₃ was obtained whose mean diameter was between 100-240 nm, and aspect ratio was 10-15.

### Example 17

2.4 L of the Ca(OH)₂ suspension that had been slaked and adjusted the concentration as prepared in the example 1 was measured, and supplemented with 0.5 L of water. The pumps and RPBs were turned on, and the rotating speed was adjusted to 1000 rpm. The temperature of the circulating water to adjusted to about 70 degrees Celsius. 10% by weight of MgCl₂ relative to the CaCO₃ formed by which the Ca(OH)₂ reacted fully was weighed, dissolved with 1 L of water and added into the tank containing the mixture. When the temperature of the reactants reached to 69.5 degrees Celsius, the gas flow meter was opened and the reaction started. The gas flow rate was maintained at 600 L/h and liquid flow rate was maintained at 2400 L/h. The pH value verse reaction time was recorded. The temperature of reactants was monitored to secure it was at 69-71 degrees Celsius. The CaCO₃ slurry was took out after reaction finished. To the dispersant agent was added several drops of CaCO₃ slurry and ultrasonic dispersion was conducted to prepare a sample for observing the morphology by TEM. The obtained powder product was dried and tested for its crystalline form by XRD. Statistical analysis disclosed that whisker type CaCO₃ was obtained whose mean diameter was between 75-200 nm, and aspect ratio was 10-25.

### Example 18

2.6 L of the Ca(OH)₂ suspension that had been slaked and adjusted as to its concentration in the example 1 was added into the mixing tank (tank for the mixture) and 0.7 L of water was supplemented. The pump for delivering the suspension and RPBs were turned on, and the rotating speed was adjusted to 950 rpm. The temperature of the circulating water was adjusted to about 60 degrees Celsius. 5.0% MgCl₂ relative to the CaCO₃ formed by which the Ca(OH)₂ reacted fully was weighed and dissolved with 0.6 L of water and then added into the mixture tank. When the temperature of the suspension reached to 59-61 degrees Celsius, the gas flow meter was opened and the reaction started. The gas flow rate was maintained at 300 L/h and liquid flow rate was maintained at 2100 L/h. The pH value verse reaction time was recorded. The temperature of reactants was monitored to secure it was at 59-61 degrees Celsius. The CaCO₃ slurry was took out after the reaction finished. To the dispersant agent was added several drops of CaCO₃ slurry and ultrasonic dispersion was conducted to prepare a sample for observing the morphology by TEM. The obtained powder product was dried and tested for its crystalline form by XRD. Statistical analysis disclosed that whisker type CaCO₃ was obtained whose mean diameter was between 50-200 nm, and aspect ratio was 12-23.

### Example 19

2.4 L of the Ca(OH)₂ suspension as prepared following the example 1 was added into the mixing tank and 0.9 L of water was supplemented. The pump for delivering the liquid reactants and RPBs were turned on, and the rotating speed was adjusted to 1350 rpm. The temperature of the circulating water was adjusted to about 40 degrees Celsius. 3.0% H₃PO₄ relative to the CaCO₃ formed by which the Ca(OH)₂ reacted fully was weighed and dissolved with 0.6 L of water and then added into the mixture tank. When the temperature of the mixture reached to 38.5 degrees Celsius, the gas flow meter was opened and the reaction started. The gas flow rate was maintained at 900 L/h and liquid flow rate was maintained at 3000 L/h. The pH value verse reaction time was recorded. The temperature of reactants was monitored to secure it was at 38-41 degrees Celsius. The CaCO₃ slurry was took out after the reaction finished. To the dispersant agent was added several drops of CaCO₃ slurry and ultrasonic dispersion was conducted to prepare a sample for observing the morphology by TEM. The obtained powder product was dried and tested for its crystalline form by XRD. Statistical analysis disclosed that whisker type CaCO₃ was obtained whose mean diameter was between 100-250 nm, and aspect ratio was 16-22.

### Example 20

2.5 L of the Ca(OH)₂ suspension that had been slaked and adjusted as to its concentration in the example 1 was added into the mixing tank and 0.2 L of water was supplemented. The pump for delivering the suspension and RPBs were turned on, and the rotating speed was adjusted to 600 rpm. The temperature of the circulating water was adjusted to about 50 degrees Celsius. 30.0% H₃PO₄ relative to the CaCO₃ formed by which the Ca(OH)₂ reacted fully was weighed and dissolved with 1.2 L of water and then added into the mixture tank. When the temperature of the suspension reached to 49.2 degrees Celsius, the gas flow meter was opened and the reaction started. The gas flow rate was maintained at 600 L/h and liquid flow rate was maintained at 2400 L/h. The pH value verse reaction time was recorded. The temperature of reactants was monitored to secure it was at 48-51 degrees Celsius. The CaCO₃ slurry was took out after reaction finished. To the dispersant agent was added several drops of CaCO₃ slurry and ultrasonic dispersion was conducted to prepare a sample for observing the morphology by TEM. The obtained powder product was dried and tested for its crystalline form by XRD. Statistical analysis disclosed that whisker type CaCO₃ was obtained whose mean diameter was between 80-240 nm, and aspect ratio was 10-20.

### Example 21

2.5 L of the Ca(OH)₂ suspension that had been slaked and adjusted as to its concentration in the example 1 was added into the mixing tank and 0.5 L of water was supplemented. The pump for delivering the suspension and RPBs were turned on, and the rotating speed was adjusted to 1200 rpm. The temperature of the circulating water was adjusted to about 80 degrees Celsius. 10.0% H₃PO₄ relative to the CaCO₃ formed by which the Ca(OH)₂ reacted fully was weighed and dissolved with 0.9 L of water and then added into the mixture tank. When the temperature of the suspension reached to 78.6 degrees Celsius, the gas flow meter was opened and the reaction started. The gas flow rate was maintained at 600 L/h and liquid flow rate was maintained at 1500 L/h. The pH value verse reaction time was recorded. The temperature of reactants was monitored to secure it was at 79-81 degrees Celsius. The CaCO₃ slurry was took out after reaction finished. To the dispersant agent was added several drops of CaCO₃ slurry and ultrasonic dispersion was conducted to prepare a sample for observing the morphology by TEM. The obtained powder product was dried and tested for its crystalline form by XRD. Statistical analysis disclosed that whisker type CaCO₃ was obtained whose mean diameter was between 90-250 nm, and aspect ratio was 12-25.

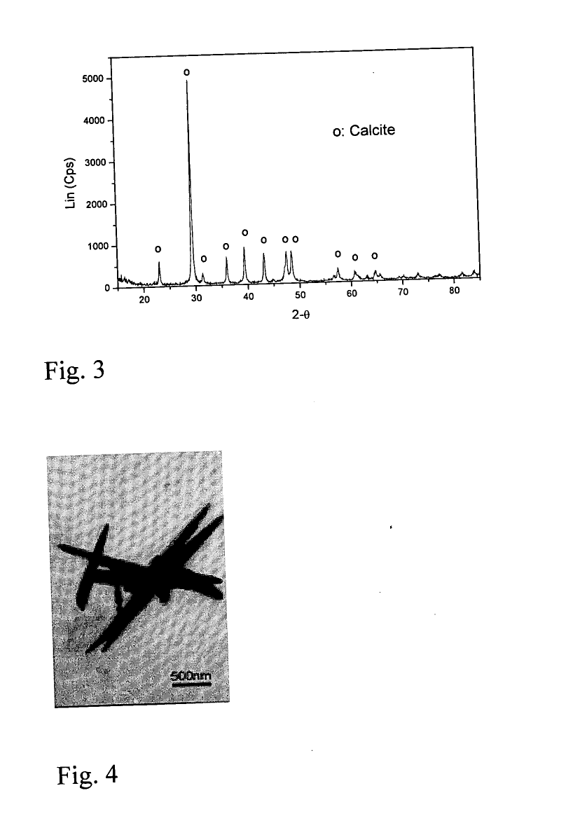

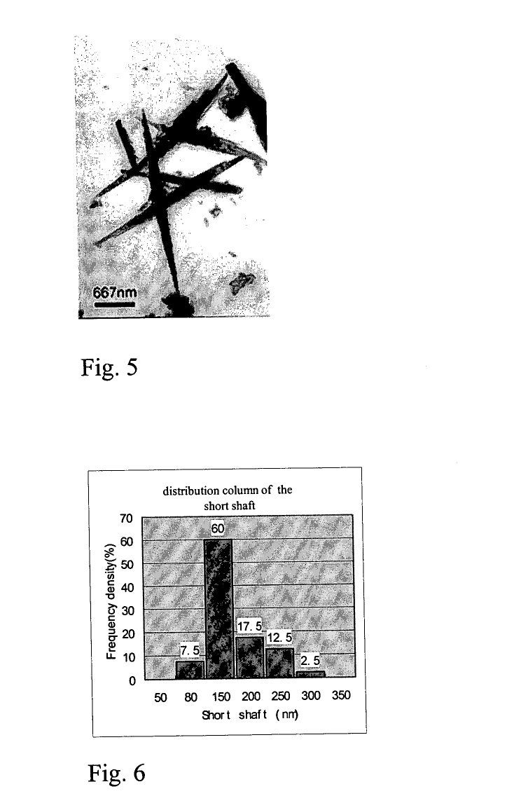

As shown in the FIG. 4 and FIG. 5, whisker type CaCO₃ of 80-250 nm in diameter and of 10-25 in aspect ratio was obtained by the process of the present invention.

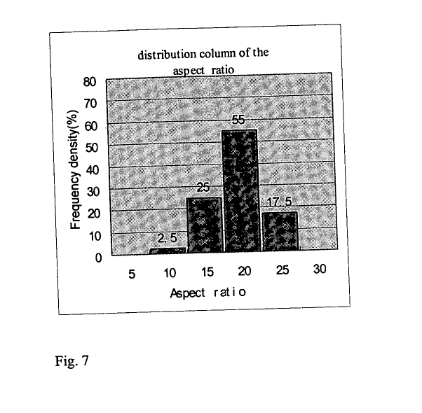

It can be seen from FIG. 6 and FIG. 7 that the whisker type CaCO₃ prepared by the process of the present invention had a narrow size distribution of diameter and aspect ratio. The mean minor axis diameter of almost 90% of all particles was between 80-250 nm, and 97.5% of aspect ratio was in 10-25. Hence, it was manifested that the CaCO₃ products by the high gravity reactive crystallization according to the invention has advantages that mean particle size (average particle size) is thin and distribution of CaCO₃ particle is uniform and narrow.

According to the process of the present invention, because the RPBs high gravity reactor is utilized, mass transfer and micro-mixing of reactants as gas-liquid interface are reinforced. So reaction time of the process of the present invention to prepare whisker type CaCO₃ is significantly shortened than conventional manufacturing process of morphological CaCO₃. Moreover, mean particle size of the CaCO₃ prepared by the process of the invention is apparently thinner than those prepared by the existing technologies.

Furthermore, high gravity technology has the merits that it can reinforce the mass transfer process greatly, the rapid and uniform micromixing can diminish the size and weight of apparatus, and residence time of reactants in the apparatus is noticeably shortened, so the manufacturing process of CaCO₃ adopting this technology are more liable to realize industrialization.

What is claimed is:

1. A process of manufacturing morphological calcium carbonate (CaCO₃), comprising allowing a suspension of calcium hydroxide (Ca(OH)₂) and a carbon dioxide (CO₂)-containing gas to have a carbonization reaction in a rotating packing bed (RPB) reactor, in the presence of either a morphology-controlling agent or a seed crystal or both, wherein the morphology of the manufactured CaCO₃ is in the form selected from the group consisting of whisker, rosette, sphere, needle, fibre, and flake.

2. The process of claim 1, wherein the rotating speed of the RPB is between about 50 rpm to about 5000 rpm.

3. The process of claim 2, wherein the rotating speed of the RPB is greater than 100 rpm and lower than 3000 rpm.

4. The process of claim 2, wherein the rotating speed of the RPB is greater than 300 rpm and lower than 3000 rpm.

5. The process of claim 2, wherein the rotating speed of the RPB is greater than 500 rpm and lower than 3000 rpm.

6. The process of claim 2, wherein the reaction temperature is between about 0 (zero) degrees Celsius to about 85 (eighty-five) degrees Celsius.

7. The process of claim 1, wherein the Ca(OH)₂ is in form of aqueous suspension and the concentration of the suspension is in the range of between about 0.01 mol/L to about 2 mol/L.

8. The process of claim 1, wherein the CO₂ is provided as a gas with a concentration of greater than 10% by volume.

9. The process of claim 1, wherein the morphology-controlling agent is selected from the group consisting of phosphoric acid and its salts, boric acid and its salts, hydroxide, chloride, ammonia, oxydol (H₂O₂), and combinations thereof.

10. The process of claim 9, wherein the morphology-controlling agent is added into the Ca(OH)₂ suspension before or in the course of reaction, or added into the reactor directly.

11. The process of claim 9, wherein the morphology-controlling agent is selected from the group consisting of alkali metal, alkaline earth metal, ammonium of phosphate, monohydrogen phosphate, dihydrogen phosphate, borate, monohydrogen borate, dihydrogen borate, ortho-borate, meta-borate, nitrate, hydroxide, and chloride, ammonia, phosphoric acid, boric acid, oxydol (H₂O₂), and combinations thereof.

12. The process of claim 10, wherein, the morphology-controlling agent is selected from the group consisting of sodium phosphate (Na₃PO₄), sodium phosphate monobasic (Na₂HPO₄), sodium phosphate dibasic (NaH₂PO₄), potassium phosphate (K₃PO₄), potassium phosphate monobasic (K₂HPO₄), potassium phosphate dibasic (KH₂PO₄), ammonium phosphate ((NH₄)₃PO₄), ammonium phosphate monobasic ((NH₄)₂HPO₄), ammonium phosphate dibasic ((NH₄)H₂PO₄), sodium borate, sodium meta-borate, boric acid, phosphoric acid (H₃PO₄), sodium hydroxide, magnesium chloride, calcium chloride, ammonia, oxydol (H₂O₂), and combinations thereof.

13. The process of claim 1, wherein the required morphological CaCO₃ is added into the Ca(OH)₂ suspension as seed crystal before the carbonization reaction.

14. The process of claim 13, wherein the morphology-controlling agent is added in an amount of between about 0.05% to about 40% by mole of Ca(OH)₂.

15. The process of claim 1, wherein the seed crystal is added in an amount of between about 0.05% to about 40% by mole of Ca(OH)₂.

16. CaCO₃ obtained by the process of claim 1.

17. CaCO₃ according to claim 16, wherein the morphology of the manufactured CaCO₃ is in the form selected from the group consisting of whisker, rosette, sphere, needle, fibre, and flake.

18. CaCO₃ according to claim 17, wherein the mean particle size of the CaCO₃ ranges between about 10 nm to about 2.5 μm.

19. CaCO₃ according to claim 17, wherein the mean particle size of the CaCO₃ ranges between about 30 nm to about 1 μm.

20. Use of the CaCO₃ of claim 16 as an additive agent selected from the group consisting of rubber, plastics, paper manufacturing, coatings, building materials, printing ink, food, pharmaceuticals, daily-use chemical, textile and feedstuffs.
